(19) United States
(12) Patent Application Publication
(10) Pub. No.: US 2022/0341108 A1
(43) Pub. Date: Oct. 27, 2022

(54) Road Safety Barrier

(71) Applicant: ANAS S.P.A., Roma (RM) (IT)

(72) Inventor: Nicola Dinnella, Rome (IT)

(21) Appl. No.: 17/753,714

(22) PCT Filed: Oct. 9, 2019
(86) PCT No.: PCT/IB2019/058588

§ 371 Date: Mar. 11, 2022

(30) Foreign Application Priority Data
Sep. 11, 2019 (IT) 102019000016088

(51) Int. Cl. E01F 15/08; G08B 25/10

(52) U.S. Cl. CPC E01F 15/083; E01F 15/088; G08B 25/10

(57) ABSTRACT

A road safety barrier including a plurality of modular blocks made of concrete placed in series and adjacent to each other near at least one of their vertical end portions including a seat that extends along the vertical direction. The road safety barrier including also, at least one anchoring element made of steel able to be placed inside said seat and having a H-shaped section being able to mutually constrain adjacent modular blocks along substantially the entire extension of the at least one of their vertical end portions, and a real time data acquiring and transmission system configured to detect an impact on at least one of the plurality of modular blocks and to transmit a real time warning to an operation center.

### TECHNICAL FIELD

The present invention relates to a road safety barrier. In particular, the present invention relates to a road safety barrier, of the New Jersey type made of concrete and having a modular structure with blocks adjacent and mutually anchored.

### BACKGROUND

The reference technical field is that of the road restraint systems, aiming at restraining and redirecting the vehicles in case of impact, at the same time reducing the consequences for the occupants of the vehicle and of other vehicles in proximity. The design, the approval, and the installation of the road restraint systems, in Italy, have to comply with the European Regulation UNI EN 1317, parts 1-4, and with the Laws n°223, dated Mar. 16, 1992, and n°2367, dated Jun. 21, 2004, and with the Ministerial Directive dated Aug. 25, 2004.

The use of the restraint systems on the roads, since they represent physical obstacles, requires specific considerations regarding design and installation.

The existing road safety barriers are used as traffic divider barriers, that is, positioned along the center lines of the roadways, or as restraint systems placed at the edges of the roadway, along an edge of a bridge or a tunnel, with the function of restraining and redirecting the vehicles according to optimized trajectories following an impact. In addition, these safety barriers have the function of absorbing part of the kinetic energy of a vehicle during the impact against the barrier.

The New Jersey type barriers, in particular, are characterized by the particular trapezoidal-shaped section, a profile aimed at minimizing damages to vehicles in the event of an accidental impact, at the same time maintaining the ability to prevent jumps into the opposite lane and a consequent potential collision with other vehicles.

Several New Jersey type road safety barriers are currently known.

A first example of a known road safety barrier is disclosed by the Italian patent ITMI20110674A1, having as its subject a side barrier or a traffic divider barrier made of concrete, steel, or other materials. The invention aims to achieve a barrier having containment levels up H4 and able to make the response to the impact homogeneous, regardless of the characteristics of the terrain and of the road pavement, and to facilitate the transportation of each disassembled module. The structure as a whole comprises a base and a continuous barrier connected to it by means of appendages placed inside a cavity, obtained inside the same base and having the function of guiding and containing the movements of the barrier in the event of an impact.

Still, the Italian patent ITPC20120004A1 describes a concrete road safety barrier, aiming to achieve a high durability of the metallic anchoring elements between adjacent modules, in particular depending on the climatic conditions. Each module is shaped in such a way so that it can be laid on the roadway, with several metallic connecting elements positioned astride of the adjacent ends of two adjacent modules. In particular, at least one of the metallic elements consists of a threaded metallic bar that crosses the ends of two adjacent modules of the barrier.

Another example of known road safety barrier is described in the patent MI2014A001457, that discloses a device aimed at connecting adjacent modules of New Jersey barriers that, in the event of an impact, has a breaking load beyond a pre-set limit and that is not rigid, so as to allow the absorption of part of the energy generated in the impact. In particular, the connection device between modules is described as a pair of threaded bars, each of which is fixed to a module of the barrier, joined by means of a plate having elastic features and adapted to deform in case of impact.

Finally, the international application WO8204272A1 describes a concrete block designed to act as a divider for roadways. The block has an essentially triangular cross section with a lower face and two lateral sides, preferably symmetrical. The primary scope of the invention is to prevent the overturning of vehicles in the event of an impact. The interconnection means between a block and the adjacent one in a traffic island are made up of metallic elements such as a pipe, a containment plate and two nuts. The blocks, at each end, have grooves in which the tubes can be inserted vertically so as to constrain adjacent blocks together.

However, the known road safety barriers suffer from limitations concerning the high values of two of the parameters that define the performances of such barriers in the event of an impact, i.e. the dynamic deflection Dₘ and the working width Wₘ, these two parameters being highly relevant in case of installation on roadways characterized by limited spaces.

A further limitation of known systems is related to the need of designing specific solutions for any kind of installation of the restraint system, which has negative consequences in terms of design complexity and economies of scale during the production phase.

### SUMMARY

The purpose of the present invention is to provide a New Jersey type road safety barrier able to ensure an adequate restraining and redirecting action on impacting vehicles and to provide reduced values of parameters such as the working width Wₘ, the dynamic deflection Dₘ and the ASI index so as to allow the installation and the right functioning on roadways characterized by limited spaces having, therefore, characteristics such as to overcome the limits that still affect the current road safety barriers with reference to the known technique.

A further purpose of the present invention is to provide a versatile road safety barrier, hereinafter referred to as NDBA (National Dynamic Barrier ANAS), different from the current devices known as New Jersey barriers, which can adapt to any installation requirement such as a traffic divider, along an edge of a bridge or a tunnel, despite being produced through a single formwork.

According to the present invention a road safety barrier is provided, as defined in the claims.

### BRIEF DESCRIPTION OF THE DRAWINGS

For a better understanding of the present invention a preferred embodiment is now described, purely by way of a non-limiting example, with reference to the attached drawings, in which:

FIG. 1 shows an overall view of a road safety barrier, according to the invention;

FIG. 2 shows a front view of a modular block of a road safety barrier, according to the invention;

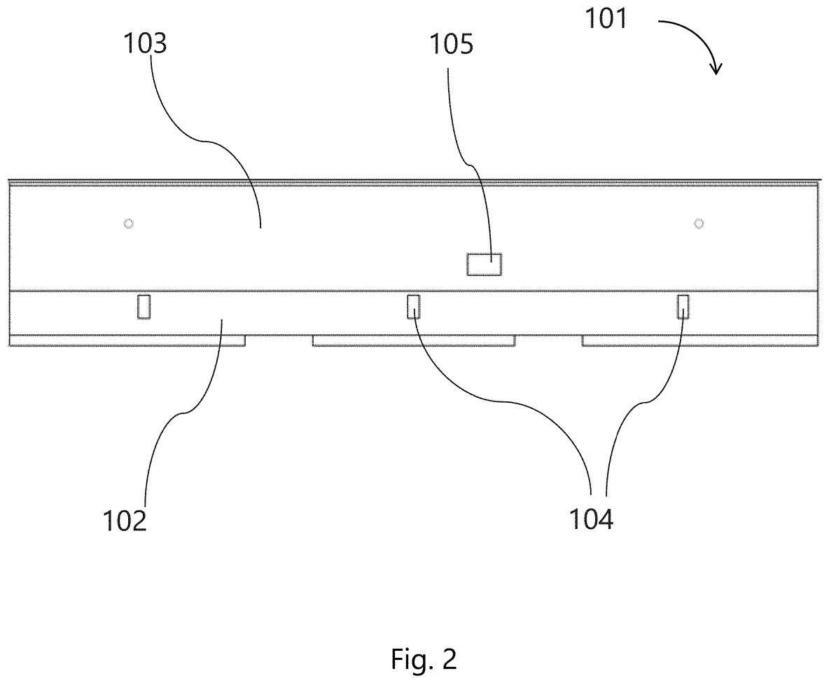

FIG. 3 shows a plant view of a modular block of a road safety barrier, according to the invention;

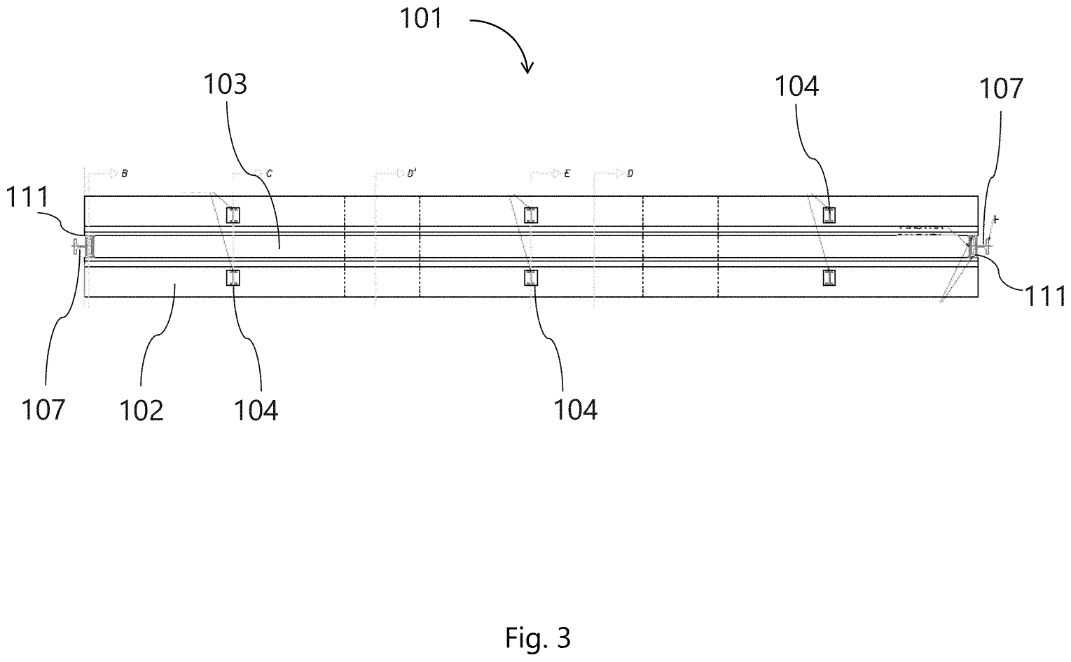

FIG. 4 shows a detail view of a fastening system for adjacent modular blocks of a road safety barrier, according to the invention;

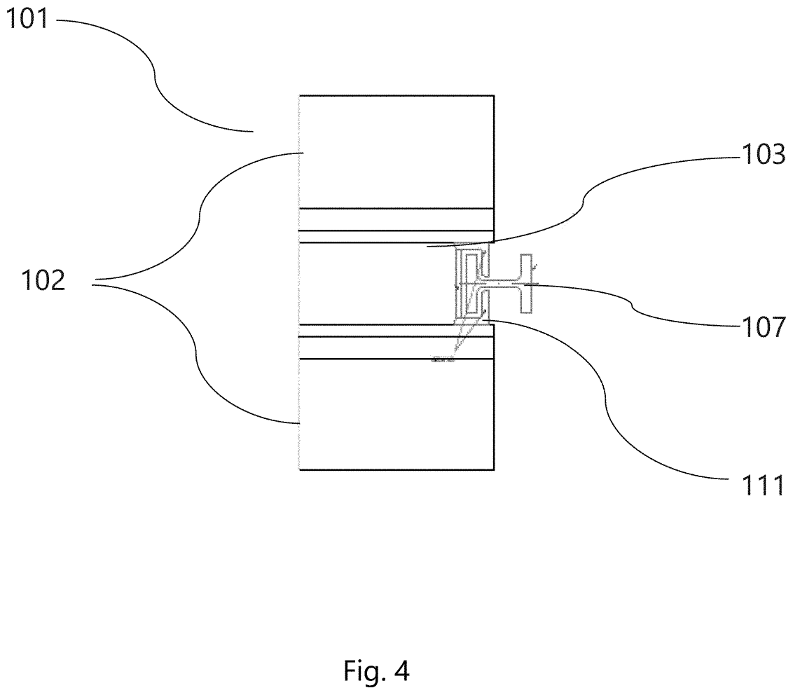

FIG. 5 shows a further sectional view of a modular block of a road safety barrier highlighting anchoring means to the roadway of said block, according to the invention;

FIG. 6 shows an additional sectional view of a modular block of a road safety barrier highlighting some cavities able to house metallic profiles and wires, according to the invention;

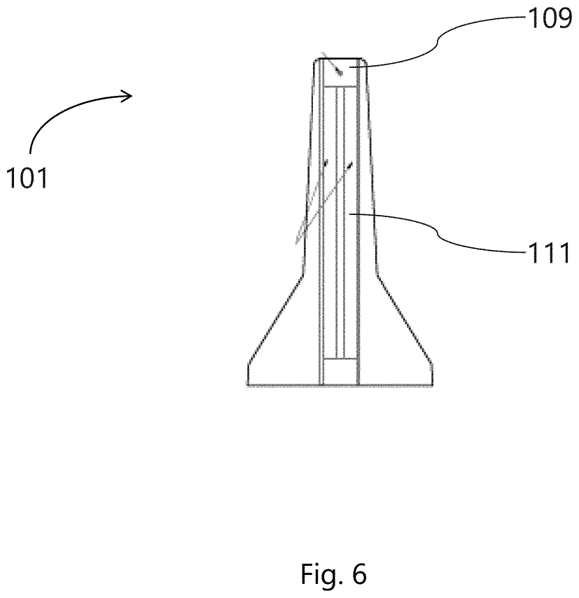

FIG. 7 shows a further sectional view of a modular block of a road safety barrier, according to the invention;

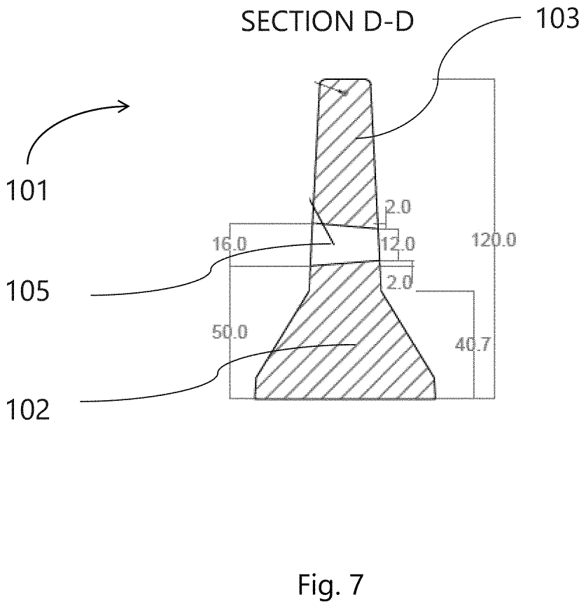

FIGS. 8a, 8b, and 8c show sectional views, respectively, of a modular block of a New Jersey barrier according to the state of art, of a modular block of a road safety barrier according to the invention, and of a modular block of a road safety barrier according to the invention overlapped to a modular block of a New Jersey barrier according to the state of art;

FIG. 9 shows a schematic view of the connection between a mini PC and at least one sensor 121 of the road safety barrier, according to the invention.

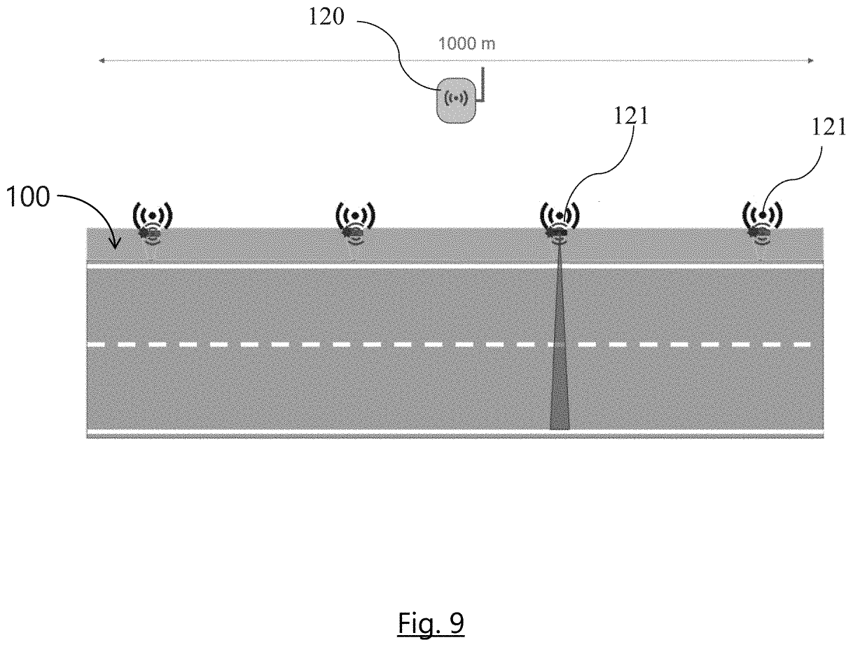

### DETAILED DESCRIPTION

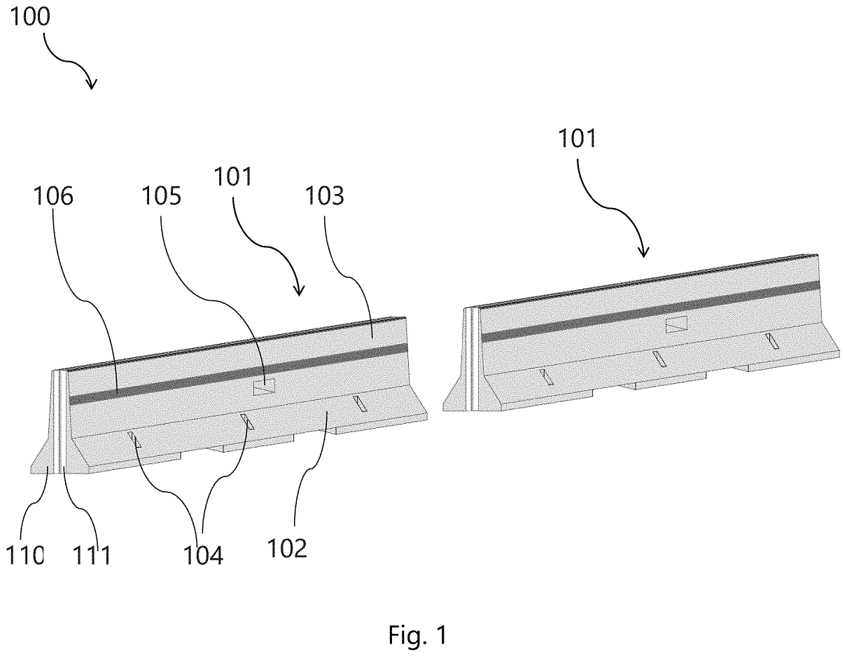

With reference to these figures and, in particular, to FIG. 1, a road safety barrier is shown, according to the invention.

In particular, the road safety barrier 100 comprises a plurality of modular blocks 101 made of concrete placed in series and adjacent to each other near at least one of their vertical end portions 110, each of said vertical end portions 110 being perpendicular to a roadway and comprising a seat which extends along the vertical direction substantially along the entire height of said end portion 110. The road safety barrier 100 comprises also at least one anchoring element 107 made of steel able to be placed inside said seat and having a H-shaped section, in particular a HEM profile, said at least one anchoring element 107 being configured to mutually constrain adjacent modular blocks 101 implementing an almost perfect joint with the seat, so as to achieve, during the kinematics of the impact, particularly low values of the Wₘ, Dₘ and ASI parameters.

In fact, as already mentioned, two of the parameters that characterize the dynamic performance of road safety barriers are the working width Wₘ, defined as the distance between the side facing a roadway before the impact and the maximum lateral dynamic position of the barrier itself, and the dynamic deflection Dₘ, defined as the maximum lateral displacement of the side of the barrier facing the roadway.

Two other performance parameters of road safety barriers, which specify their behavior following an impact, are the aforementioned ASI (Acceleration Severity Index) and the THIV (Theoretical Head Impact Velocity), whose combination allows to express the severity level of the impact, within a range expressed by the three classes ‘A’, ‘B’ and ‘C’.

Furthermore, additional parameters concerning road safety barriers define the containment level of said barriers following the impact with a heavy vehicle and the severity of the impact with a light vehicle, according to a reference scale indicated with the abbreviations ‘T’, ‘N’, ‘L’ or ‘H’. For example, a ‘H4b’ road safety barrier has successfully passed, in accordance with the reference regulations, both a TB11 crash test with a 900 kg vehicle, at 100 km/h and with an impact angle of 20°, that a TB81 crash test with a 38 tons heavy vehicle launched on the barrier at 65 km/h with an impact angle of 20°.

According to an aspect of the invention, each modular block 101 is composed of a base 102 having a substantially trapezoidal section resting on the roadway, and of an upper portion 103 which extends without interruption on the base 102. The upper portion 103 has a section of an isosceles trapezoid with slope of the oblique sides greater than the slope, measured with respect to the roadway, of the oblique sides of the base 102.

According to another aspect of the invention, the modular blocks 101 are prefabricated and made as monolithic concrete blocks.

According to another aspect of the invention, each end portion 110 of the modular block 101 comprises a hollow metallic profile 111, fixed to the modular block 101, in which, in use, an anchoring element 107 is housed.

In particular, the metallic profile 111 is composed of a flat plate and two angular profiles opposite to each other, such as to define a central cavity having a substantially rectangular shape. The flat plate can be welded to the two angular profiles, or the three parts can constitute a single metallic element. The metallic profile 111 is preferably fixed to the concrete modular block 101 during the casting phase into the formwork used for the production.

Advantageously according to the invention, fixing adjacent modular blocks 101 by means of the anchoring elements 107 allows to significantly reduce the working width Wₘ and the dynamic deflection Dₘ, with respect to the known technical solutions.

A further advantage related to the use of the anchoring elements 107 is that the kinematic motion that is generated during an impact causes the instantaneous and the permanent deformation to be smaller than those that would occur with the known technical solutions, specifically with the traditional hinge constraint.

The Applicant carried out an additional experimental test on the road safety barrier 100 according to the invention, that is, a second crash test of a heavy vehicle according to the TB81 crash test specifications on a portion of the barrier 100 already stressed by the same test. The TB81 crash test, repeated twice on the same point of the road safety barrier 100, highlighted the high strength and optimization of the assembly modular blocks 101—anchoring elements 107. The resistance of the road safety barrier 100, demonstrated experimentally also by means of the second TB81 crash test, is particularly advantageous in terms of maintenance costs and management of the restoration interventions. In fact, even in the unlikely event of two accidents occurring at the same point of the road safety barrier 100 and within a limited time interval, the technical characteristics of the invention allow to maintain high safety standards and to ensure optimal performances, allowing to reduce the need for immediate restoration interventions and to plan maintenance interventions, optimizing said interventions and reducing their costs.

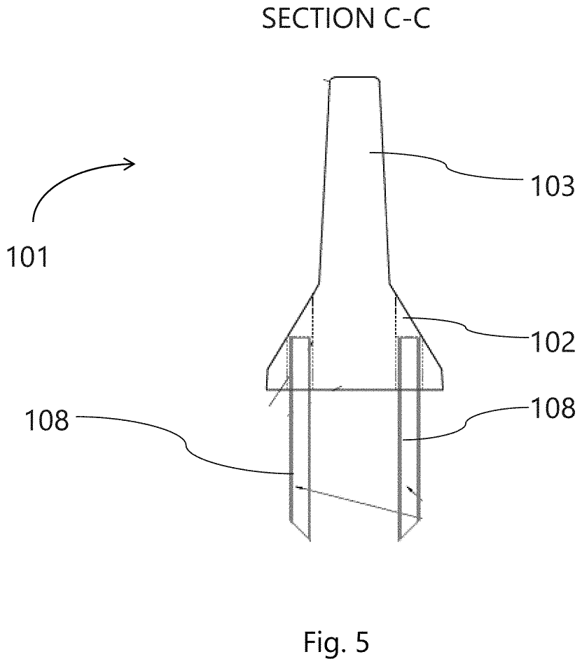

According to an aspect of the invention, as shown in FIG. 5, each modular block 101 comprises, at its base 102, at least one cavity 104 able to house metallic means 108 for anchoring the modular block 101 to the roadway. In the embodiment shown in the figures, the modular block 101 of the road safety barrier 100 comprises on each side of the base 102 three vertical cavities 104.

In use, the use of a variable number of metallic means 108, leaving one or more cavities 104 empty, allows to vary the dynamic response of the road safety barrier 100 according to the type of installation and to the specific requirements and to achieve working widths comprised between W2 and W5.

Advantageously according to the invention, the working width W2, achieved by fixing metallic means 108 into the roadway in all the cavities 104 of the portion of the road safety barrier 100 considered, allows the use of said road safety barrier 100 on roadways characterized by limited spaces.

According to an aspect of the invention, the modular block 101 comprises, at a height comprised between 40 cm and 60 cm, and preferably of 50 cm from the roadway, a hollow seat 105 configured to facilitate the crossing of a user from one side to the other of the road safety barrier 100. This possibility is particularly useful in the event of a car accident to allow a user to climb over said modular block 101, in a protected area.

The road safety barrier 100 is built starting from a single steel formwork, regardless of the different final configurations and of the different road infrastructures for which it is intended.

Advantageously according to the invention, the road safety barrier 100, being able to be built starting from a single steel formwork for any type of final installation, ensures a fast, efficient and inexpensive production line.

A further advantage of the road safety barrier 100 according to the invention is that it allows to use the same profile of the barrier for any possible installation conditions, allowing to adapt the restraint system to the road infrastructure, as opposed to what happens for the currently known restraint systems, and to harmonize the barriers present over the entire road network with an increase in comfort levels for users quite valuable.

In use, advantageously, the road safety barrier 100 according to the invention is versatile in that it lends itself to different constraint configurations, designed and arranged in the line formwork, and is therefore adaptable to different specific installation conditions, depending on the available space, on the type of road, on the levels and kind of traffic.

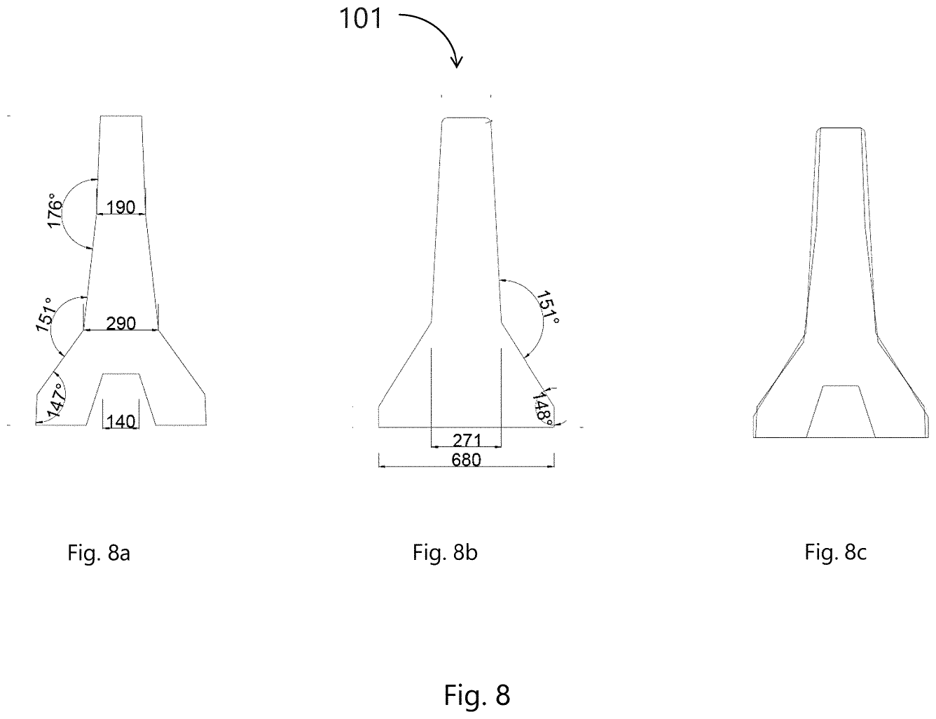

FIG. 8 shows a graphic comparison between a modular block 101 according to the invention and a modular block of a New Jersey type barrier according to the state of art. In particular, the base 102 has a bottom side, in correspondence with the support to the roadway, having a width greater than that of the blocks of the known systems, in particular equal to 68 cm with respect to the 66 cm-width of the blocks of the known systems.

Furthermore, the modular block 101 according to the invention has a side profile having a first section close to the roadway having a height preferably of 8 cm and substantially vertical, a second section having a height preferably of 32.7 cm and a third section having a height preferably of 79.3 cm.

Each section contributes to the outcome of the ASI index that in the road safety barrier 100 according to the invention is lower than that obtained through the known commercial profiles, i.e. known New Jersey type modular blocks. Altogether, the modular block 101 has a height, with respect to the roadway, of 120 cm. The first section and the second section form an angle of 148° between them, the second section and the third section form an angle of 151° between them.

In the traditional known blocks, with reference to the prior art and to FIG. 8a, the first section close to the roadway has a height of 12 cm, the second section has a height typically of 25 cm, the first section and the second section forming between them an angle of 147°. The third section has a height of 45 cm, and the angle between the second and the third section in the currently known barriers blocks is 151°. In the currently known blocks, a fourth section is provided, positioned over the previous ones, having a height of 38 cm, and forming an angle of 176° with the third section.

The particular geometry of said modular block 101, and in particular the angles of the base 102, allow to obtain in a TB11 crash test an ASI index equal to 1.3, as highlighted through the experimental tests, which results in an acceleration to which the occupants of the vehicles are subjected in the event of an impact 10% lower, compared to the currently known New Jersey blocks.

According to an aspect of the invention, the overall length of the modular block 101 is preferably of 6 m.

Advantageously according to the invention, the road safety barrier 100, thanks to its conformation and to the fixing means of the modular blocks 101, is able to be installed in correspondence with road curves having a minimum turning radius of 65 m.

According to an aspect of the invention, the road safety barrier 100 does not require foundation structures in the roadway, since the plurality of modular blocks 101 lays directly on the wear layer.

Advantageously, the road safety barrier 100 according to the invention allows a significant reduction of the execution times of the works, of the safety burdens related to the construction activities for the division and the construction sites which are generally necessary for the positioning of the barriers. In addition, activities such as periodic grass mowing, and their concerning costs, are significantly reduced, and so is the use of personnel assigned to the aforementioned activities, producing at the same time relevant benefits in terms of reducing the relative risk of the maintenance activities with vehicles in transit.

A further advantage of the road safety barrier 100 according to the invention is that the metallic means 108 are fixed into the roadway through the use of pile-driving machines available on the market at low costs, allowing a fast and inexpensive installation.

According to an aspect of the invention, the road safety barrier 100 comprises a real-time data acquisition and transmission system configured to detect an impact on a modular block 101 and to transmit a warning, together with the data concerning the geolocation of the event in real time, to an operating center.

According to an aspect of the invention, the real-time data acquisition and transmission system comprises an industrial mini PC 120 connected to at least one sensor 121 configured to detect an impact, said industrial mini PC 120 comprising a wireless communication module. Said mini PC 120 is intended as a master device configured to collect and process data transmitted form at least one sensor 121 and to send said data through internet connection to a remote system.

Advantageously according to the invention, the real-time data acquisition and transmission system allows a prompt intervention in order to restore road safety, and an optimal organization of relief for the users involved in a car accident.

According to an aspect of the invention, the data acquisition and transmission system is configured for transmitting an alarm and signaling the potential danger to other incoming vehicles within a certain distance from the modular block 101 involved in the impact.

A further advantage ensured by the real-time data acquisition and transmission system is that it allows to record a plurality of accident-related parameters that can be used as a database to be analyzed in order to continuously improve the technical specifications of road safety barriers 100 over all roadways where they are installed.

According to another aspect of the invention, the wires of said real-time data acquisition and transmission system are housed inside a cavity 109 formed at the upper portion 103 of each modular block 101 and pass through the entire length of said upper portion 103.

According to another aspect of the invention, each modular block 101 comprises a reflective strip 106, preferably of a blue color, positioned along both opposite sides of the upper portion 103 oriented along the direction of vehicular traffic, and preferably at a height of one meter from the roadway.

Advantageously according to the invention, the reflective strip 106 allows a driving user, both day and night, a comfortable optical perception of the roadway, particularly useful in conditions of low visibility.

Another advantage of the road safety barrier 100 according to the invention is that the height of said road safety barrier 100 allows to eliminate the glare phenomena during night driving conditions.

According to another embodiment, not shown in figure, the road safety barrier according to the invention, as previously described, is designed to be used according to various types of installation and, in the case of the second embodiment, as a safety barrier along the edges of bridges and tunnels.

Such a result is achieved, during the production phase, by isolating a section of the formwork corresponding to a portion of the base 102 with respect to the already described symmetrical embodiment related to the use of the barrier as a traffic divider.

Advantageously according to the invention and as already described for the first embodiment, the use of a variable number of anchoring means into the roadway allows to achieve a lower working width, i.e. equal to W2 and corresponding for the NDBA to 0.8 meters, particularly suitable for this type of installation characterized by greater potential danger caused by the edges of the roadways along bridges and tunnels.

The present invention also relates to a production process of a road safety barrier 100, able to be used as a traffic divider and along the edges of bridges and tunnels, comprising the steps:

of making a formwork having dimensions and geometry unique for any final use of the road safety barrier 100;

of placing inside the formwork, a steel armor and C-shaped hollow steel profiles near the end portions of the formwork;

of making a concrete casting, preferably using fiber-reinforced concrete;

of extracting the formwork through the rotation of the same formwork and the expulsion of the concrete modular block 101.

According to an aspect of the invention, in the event that a barrier 100 is produced to be installed along the edges of bridges and tunnels, the step of inserting a steel reinforcement and the C-shaped steel hollow sections at the end portions of the formwork, is preceded by a phase of:

isolating an upper portion of the formwork corresponding to a portion of the base 102 of the block 101 to be produced, by means of a removable partition.

Advantageously according to the invention, the formwork will be the same even in case of the production of a road safety barrier intended to be installed along the edges of bridges and tunnels. In this case, in fact, before casting the concrete, a partition inside the formwork is simply and quickly arranged in order to isolate a portion of the same formwork.

Advantageously according to the invention, the production process of the road safety barrier 100 allows to reduce the costs and the complexity of production and installation, with respect to the technical solutions related to currently known New Jersey type safety barriers.

Therefore, the road safety barrier 100 according to the invention allows to implement a New Jersey type restraint and redirect system to be used on roadways as a traffic divider barrier, along the edges of a bridge or along the edges of a tunnel.

Another advantage of the road safety barrier according to the invention is that it allows to reduce the dynamic deflection following an impact, with respect to the known systems, adapting to multiple installation conditions.

In addition, the road safety barrier according to the invention is efficient, inexpensive both in terms of initial investment and maintenance, and it is of easy and fast installation.

Finally, the road safety barrier according to the invention adapts to roadway ensuring ease of installation and economies of scale.

It is finally clear that the road safety barrier described and illustrated herein can be subject to modifications and variations without departing from the protective scope of the present invention, as defined in the appended claims.

1. A road safety barrier comprising a plurality of modular blocks made of concrete placed in series and adjacent to each other near at least one of their vertical end portions, each of said end portions including a seat that extends along the vertical direction, said road safety barrier including at least one anchoring element made of steel able to be placed inside said seat and having a H-shaped section, said at least one anchoring element being able to mutually constrain adjacent modular blocks along substantially the entire extension of the at least one of their vertical end portions); a real time data acquiring and transmission system configured to detect an impact on at least one of the plurality of modular blocks and to transmit a real time warning to an operation center, said real time data acquiring and transmission system includes an industrial mini PC connected to at least one sensor configured to detect an impact, said industrial mini PC including a wireless communication module and a GPS module.

2. The road safety barrier according to claim 1, wherein each modular block is composed of a base having a section substantially trapezoidal and of an upper portion that extends without interruption over the base, said upper portion forming in section an angle of 151° with the base.

3. The road safety barrier according to claim 1, wherein said end portions includes a C-shaped hollow metallic profile able to house the anchoring element.

4. The road safety barrier according to claim 1, wherein each modular block comprises, near its base, at least one cavity able to vertically house metallic means for anchoring the modular block to the roadway.

5. (canceled)

6. (canceled)

7. The road safety barrier according to claim 1, wherein comprising a hollow seat, placed inside the upper portion of the modular block at a distance of 50 centimeters form the roadway and able to allow a user to climb over said modular block.

8. The road safety barrier according to claim 15, wherein said at least one of the plurality of modular blocks comprises in its upper portion a cavity that crosses the entire length of said upper portion, said cavity being able to house wires of the real time data acquiring and transmission system.

9. The road safety barrier according to claim 1, wherein each modular block comprises a reflective strip placed near the upper portion.

10. Road The road safety barrier according to claim 1, wherein at least one of the plurality of modular blocks has a height of 120 centimeters and a length of 6 meters.

11. A production process of a road safety barrier according to claim 1, comprising the steps of:
making a formwork having dimensions and geometry unique for any final use of the road safety barrier;
placing inside the formwork, a steel armor and C-shaped hollow steel profiles near the end portions of the formwork;
making a concrete casting;
extracting the formwork through the rotation of the same formwork and the expulsion of the concrete block.
